(19) United States
(12) Patent Application Publication
(10) Pub. No.: US 2014/0017423 A1
(43) Pub. Date: Jan. 16, 2014

(54) APPARATUS, SYSTEM AND/OR A METHOD FOR HOLDING A POLE

(71) Applicants: Ralph Veazey, Pierport, MI (US); Pierre Dahmani, Pierport, MI (US)

(72) Inventors: Ralph Veazey, Pierport, MI (US); Pierre Dahmani, Pierport, MI (US)

(21) Appl. No.: 13/942,939

(22) Filed: Jul. 16, 2013

Related U.S. Application Data
(60) Provisional application No. 61/672,128, filed on Jul. 16, 2012.

(51) Int. Cl. F16M 13/00

(52) U.S. Cl. CPC F16M 13/00
USPC 428/34.1; 248/544

(57) ABSTRACT

The present disclosure provides an apparatus for mounting a pole, the apparatus comprising a plate and one or more fins. The present disclosure also provides methods for mounting a pole using an apparatus as disclosed herein.

### PRIORITY CLAIM

This application claims priority to U.S. provisional patent application Ser. No. 61/672,128, filed on Jul. 16, 2012, the entire contents of which are hereby incorporated by reference and relied upon.

### BACKGROUND

The present disclosure generally relates to an apparatus, a system and/or a method for holding a pole. More specifically, the present disclosure relates to an apparatus, a system and/or a method that may be used to hold, to stabilize, and/or to secure a pole to a surface. The pole may be any type of post and/or mast desired to be set in place. Accordingly, the pole may include, for example, an umbrella pole, a pop-up canopy or tent, a flag pole, a fence post, a post utilized in sports, an event tent, a supermarket tent, and/or the like. The surface may be, for example, a deck surface, a lawn, a sandy surface or beach, a gravel surface, concrete and/or any other surface onto which a pole may be affixed.

The apparatus, the system and/or the method may incorporate a tube into which the pole may be fitted. The apparatus, the system and/or the method may also incorporate a plate with an anchoring fin. The fin may restrict movement and/or shifting of the plate, the tube, and/or the pole by being wedged and/or fitted in a space between decking boards and/or any other longitudinal space in a surface. The fin may also be driven and/or planted into a loose surface, such as, sand, dirt, and/or gravel.

A pole, a post, and/or a rod may be set vertically or substantially vertical in many ways. For example, a beach umbrella may be secured by driving a base pole of the umbrella into sand. Similarly, a shade umbrella may be placed on a surface using various stands. Regardless of their specific application, umbrellas may be subject to harsh natural weather conditions including strong winds and/or other forms of inclement weather. More specifically, strong winds can cause umbrellas to exert strain upon their respective bases as the umbrellas shift and sway in response to the wind. Currently available umbrellas may not able to withstand such inclement weather conditions due to insufficient construction and/or structural reinforcement, for example. Moreover, currently available umbrellas may fail to include a stand and/or fixture assembly that is designed to overcome the dangers presented by wind and/or other natural forces that may cause the pole supporting the umbrella to snap or otherwise fail.

Moreover, existing systems and apparatus for securing a pole are often restricted to installation on specific surfaces. For example, a staked stabilizing pole may be restricted to non-rigid and/or loosely held surfaces such as grass or sand. The stake, due to its design for penetration into grass or sand, may not be correctly installed on a rigid surface such as a deck. Further, to provide a strong base, many currently available umbrellas require permanent modifications to the surfaces to which they attach such as screws, nails and/or other fasteners. These fasteners are difficult to install and/or remove and may further deface the surface onto which the pole is mounted.

Thus, there is a need for an apparatus, a system and/or a method that may be used to hold, to stabilize, and/or to secure a pole to a surface. Further, there is a need for an apparatus, a system and/or a method for holding a pole that may allow for easy mounting of the pole without requiring additional tools and/or equipment. Still further, there is a need for an apparatus, a system and/or a method for holding a pole that may be used on a variety of surfaces. Even further, there is a need for an apparatus, a system and/or a method that may conform to a preexisting rigid structure, such as a deck. Still further, there is a need for an apparatus, a system and/or a method that may secure a pole and/or an apparatus to restrict movement of the same in instances of strong wind or other inclement weather. Even further, there is a need for an apparatus, a system and/or a method for holding a pole in place by using preexisting slots and/or spaces in a surface. Still further, there is a need for an apparatus, a system and/or a method for easily uninstalling and/or removing a pole from a surface. Still further, there is a need for an apparatus, a system and/or a method for easily and/or inexpensively creating a pole apparatus, system and/or method directed toward holding the pole in place.

### SUMMARY

The present disclosure generally relates to an apparatus, a system and/or a method for holding a pole. More specifically, the present disclosure relates to an apparatus, a system and/or a method that may be used to hold, to stabilize, and/or to secure a pole to a surface and/or a ground. The pole may be any type of pole and/or mast desired to be held in place. The pole may be, for example, an umbrella pole, a pop-up canopy or tent, a flag pole, a fence post, an event tent, a supermarket tent, and/or a post utilized in sports. The surface may be, for example, a deck surface, a lawn, a sandy surface or beach, a gravel surface, concrete, and/or any other surface onto which a pole may be affixed.

The apparatus, the system and/or the method may incorporate a tube into which the pole may be fitted. The apparatus, the system and/or the method may also incorporate a plate with one or more anchoring fins. The fins may be used secure the pole to restrict movement and/or shifting of the plate, the tube, and/or the pole. The one or more fins may be inserted, wedged and/or otherwise fitted in spaces between decking boards and/or any other longitudinal spaces disposed in a surface. Additionally, the one or more fins may also be driven and/or planted into a loosely held surface, such as, sand, dirt, gravel and the like.

The one or more fins may resemble generally rectangular plates extending perpendicularly from a base plate holding the pole. Alternatively, the one or more fins may be shaped and/or curved depending on the conditions of the surface on which the umbrella is to be mounted. The one or more fins may be arranged in any configuration on a bottom surface of a base plate. For example, the one or more fins may be arranged in parallel and/or perpendicular arrangement or at any angle with respect to each other. In an embodiment, stakes may be used alone or in conjunction with the fins. For instance, the stakes may be driven into the surface through holes in the plate.

To this end, in an embodiment, an apparatus for holding a pole is provided. The apparatus comprises a plate having a top surface, a bottom surface and a width. A tube is positioned on the top surface of the plate, in some embodiments substantially perpendicular to the plate. The tube has an opening for receiving the pole therein. The apparatus also has a first fin having a depth and a width positioned on the bottom surface of the plate. In some embodiments, the first fin extends substantially perpendicularly from the bottom surface of the plate. In some embodiments, the first fin extends substantially the width of the plate. In an embodiment, the first fin is curved. In an embodiment, the first fin is triangularly shaped and comprises an opening through the fin. In some embodiments, the first fin comprises a beveled edge portion.

In one embodiment, the apparatus includes a single fin.

In other embodiments, the apparatus comprises a second fin on the bottom surface of the plate positioned at an angle relative to the fin. In an embodiment, the second fin is curved. In an embodiment, the second fin is triangularly shaped and comprises an opening through the fin. In some embodiments, the second fin comprises a beveled edge portion. In some embodiments, the second fin is positioned substantially parallel to the first fin. In some embodiments, the second fin is separated from the first fin by a distance corresponding to a width of a surface onto which the plate is positioned. In such embodiments, the apparatus may be positioned such that the first fin and the second fin straddle the width of the surface.

In an embodiment, the plate, the tube and the first fin are integrally formed.

In an embodiment, the one or more fins is resilient. In an embodiment, the one or more fins each have a cut-out portion.

In an embodiment, the first fin penetrates a surface onto which the plate is positioned.

In another embodiment, a system for holding a pole is provided. The system has a plate having a top surface and a bottom surface, and an orifice extending through the plate from the top surface to the bottom surface. The system also has a tube having a first end, a second end and an opening for receiving the pole therein. The first end is inserted through the orifice in the plate. The system further has an anchor plate having a top surface positioned substantially perpendicular to the second end of the tube. The top surface of the anchor plate abuts the bottom surface of the plate. Finally, the system has a fin having a depth and a width positioned on the bottom surface of the plate. The depth of the fin extends substantially perpendicularly from the bottom surface of the plate and the width of the fin extends substantially the width of the plate.

In an embodiment, the system has a stake inserted through a hole in the plate into a surface onto which the plate is positioned.

In an embodiment, the system has a slotted opening extending into the bottom surface of the plate, and a tab located on the fin corresponding to the slotted opening. The tab is configured and arranged to insert into the slotted opening in the plate.

In an embodiment, the system has a flange on the anchor plate that abuts the fin on the bottom surface of the plate.

In another embodiment, an apparatus for holding a pole is provided. The apparatus comprises a plate having a top surface, a bottom surface and a width, and a protrusion extending substantially perpendicularly from the top surface of the plate. An attachment may be secured to the protrusion wherein the pole connects to the attachment. The apparatus has a fin having a depth and a width. The depth of the fin extends substantially perpendicularly from the bottom surface of the plate and the width of the fin extends substantially the width of the plate.

In yet another embodiment, an apparatus for holding a pole is provided. The apparatus comprises a plate having a top surface, a bottom surface, a width and a length, and a single fin affixed to the bottom surface of the plate. In some embodiments, the fin extends substantially the entire width of the plate. In some embodiments, the fin includes a beveled edge portion which, in some embodiments, extends substantially the entire width of the fin.

In any embodiment disclosed herein, the pole may have a polygon cross-sectional shape. In some embodiments, the polygon cross-sectional shape is selected from the group consisting of: circle, square, rounded square, or squircle.

In a further embodiment, a method for mounting or holding a pole on a surface is provided. The method comprises the steps of placing a plate on the surface; securing the plate to the surface; and attaching a pole to the plate.

In an embodiment, the method comprises the steps of creating an opening in the surface; and inserting a fin connected to the plate into the opening to secure the plate to the surface.

In an embodiment, the surface is a deck having decking boards separated by a gap. The method has the step of inserting a fin connected to the plate into the gap between the decking boards to secure the plate to the surface.

In an embodiment, the surface has bricks, and the method has the step of inserting a fin connected to the plate into a space between the bricks to secure the plate to the surface.

In an embodiment, the method has the step of inserting a stake through a hole in the plate into the surface to secure the plate to the surface.

It is, therefore, an advantage of the present disclosure to provide an apparatus, a system and/or a method for holding a pole.

Another advantage of the present disclosure is to provide an apparatus, a system and/or a method for holding a pole which uses a tube, plate, and/or anchoring fins.

Another advantage of the present disclosure is to provide an apparatus, a system and/or a method for securing and/or stabilizing a pole with respect to a surface.

And, another advantage of the present disclosure is to provide an apparatus, a system and/or a method that may be used to restrict movement of a pole and/or the apparatus due to a force applied to the pole.

Yet another advantage of the present disclosure is to provide an apparatus, a system and/or a method for facilitating simplified installation of a pole at a location.

A further advantage of the present disclosure is to provide an apparatus, a system and/or a method for holding a pole using preexisting slots and/or spaces in a surface.

Moreover, an advantage of the present disclosure is to provide an apparatus, a system and a method for restricting movement of a pole in a loose surface and/or a semi-loose surface.

And, another advantage of the present disclosure is to provide an apparatus, a system and a method for holding a pole that requires no force and/or tools for installation.

Yet another advantage of the present disclosure is to provide an apparatus, a system and a method for holding a pole which allows for the pole to be easily uninstalled and/or removed from the surface.

A still further advantage of the present disclosure is to provide an apparatus, a system and a method for holding a pole which restricts liquid from collecting in the tube and/or the plate.

Moreover, an advantage of the present disclosure is to provide an apparatus, a system and a method for holding a pole which securely fastens the pole into the tube.

And, another advantage of the present disclosure is to provide an apparatus, a system and a method for holding a pole using the pole as a stabilizing component in addition to other stabilizing components.

Moreover, an advantage of the present disclosure is to provide an apparatus, a system and a method for holding a pole that may provide a minimalistic aesthetic quality.

Yet another advantage of the present disclosure is to provide an apparatus, a system and/or a method for holding a pole that may be easy and/or inexpensive to construct.

### BRIEF DESCRIPTION OF THE DRAWINGS

FIG. 1 illustrates a perspective view of an apparatus for holding a pole having two protruding fins arranged in parallel in an embodiment of the present disclosure.

FIG. 2 illustrates a bottom plan view of the apparatus shown in FIG. 1.

FIG. 3 illustrates a side view of the apparatus shown in FIG. 1.

FIG. 4 illustrates a perspective view of an apparatus for holding a pole using a curved fin in an embodiment of the present disclosure.

FIG. 5 illustrates a bottom view of the embodiment of the apparatus shown in FIG. 4.

FIG. 6 illustrates a perspective view of an apparatus for holding a pole having two protruding fins arranged perpendicular to one another in an embodiment of the present disclosure.

FIG. 7 illustrates a bottom plan view of the apparatus shown in FIG. 6.

FIG. 8 illustrates a perspective view of an apparatus for holding a pole having holes in a base plate in another embodiment of the present disclosure.

FIG. 9 illustrates a perspective view of an apparatus for holding a pole in yet another embodiment of the present disclosure.

FIG. 10 illustrates a perspective view of an apparatus for holding a pole having a single fin that is curved about an axis perpendicular to a pole in an embodiment of the present disclosure.

FIG. 11 illustrates a side view of the embodiment of the apparatus shown in FIG. 10.

FIG. 12 illustrates a perspective view of an apparatus for holding a pole having a single fin protruding in direction perpendicular to a plate in an embodiment of the present disclosure.

FIG. 13 illustrates another perspective view of the embodiment of the apparatus shown in FIG. 12.

FIG. 14 illustrates a perspective view of the apparatus shown in FIG. 12 with a tube detached from a plate of the apparatus.

FIG. 15 illustrates another perspective view of the apparatus shown in FIG. 12 with a tube detached from a plate of the apparatus.

FIG. 16 illustrates a perspective view of another embodiment of an apparatus for holding a pole having a triangularly-shaped protruding fin with a cut-out portion.

FIG. 17 illustrates another perspective view of an apparatus for holding a pole having a triangularly-shaped protruding fin with a cut-out portion.

FIG. 18 illustrates a perspective view of another embodiment of an apparatus for holding a pole having a protruding fin with a cut-out portion with a pole extending from a plate of the apparatus.

FIG. 19 illustrates a perspective view of an embodiment of an apparatus for holding a pole having several cut-out sections in a plate.

FIG. 20 illustrates a perspective view of the apparatus in FIG. 19 with an attachment device to mount a pole attached to a plate.

FIG. 21 illustrates a view of the apparatus in FIG. 19 in operation in an embodiment of the present disclosure.

FIG. 22 illustrates perspective (FIG. 22A) and cross-sectional (FIG. 22B) views of an embodiment of an apparatus for holding a pole.

FIG. 23 illustrates perspective (FIG. 23A) and cross-sectional (FIG. 23B) views of an embodiment of a pole having a cross-sectional shape of a rounded square, which is suitable for use with any apparatus or method disclosed herein.

### DETAILED DESCRIPTION

The present disclosure generally relates to an apparatus, a system and/or a method for holding a pole. More specifically, the present disclosure relates to an apparatus, a system and/or a method that may be used to hold, to stabilize, and/or to secure a pole to a surface and/or the ground. The pole may be any type of pole and/or mast desired to be held in place. The pole may be, for example, an umbrella pole, a post of a pop-up canopy or tent, a flag pole, a fence post, and/or a post utilized in sports. The surface may be, for example, a deck surface, a lawn, a sandy surface or beach, a gravel surface, concrete and/or any other surface onto which a pole may be affixed.

The apparatus, the system and/or the method may incorporate a tube into which the pole may be fitted. The apparatus, the system and/or the method may also have a plate with one or more anchoring fins. The fins may be used to restrict movement and/or shifting of the plate, the tube, and/or the pole. The fins may be wedged and/or fitted in spaces between decking boards and/or any other spaces disposed in a surface. The fins may also be driven and/or planted into a loose surface, such as, sand, dirt, gravel and the like.

In an embodiment, the fins may be generally rectangular plates extending perpendicularly from the plate. Alternatively, the fins may be shaped and/or curved depending on the desired surface. The fins may be arranged in any configuration on a bottom surface of the plate. For example, the fins may be arranged in a parallel and/or perpendicular arrangement or any other angle with respect to each other. In an embodiment, stakes may be used alone or in conjunction with the fins. The stakes may be driven into the ground through holes that may be disposed in the plate.

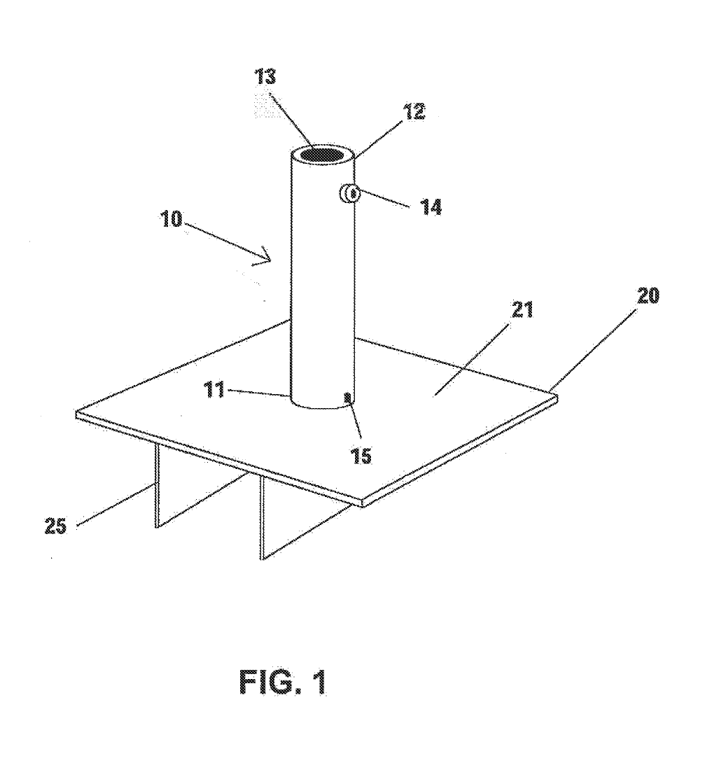

Referring now to the drawings wherein like numerals refer to like parts, FIG. 1 illustrates an apparatus and/or system for holding a pole. The apparatus and/or system may generally have a tube 10 and a plate 20. The tube 10 may be affixed to the plate 20 in an embodiment of the present disclosure. The plate 20 may have anchoring fins 25 (herein “fins 25”) for anchoring the plate, the tube, and/or the pole onto and/or into a surface. The pole may be a portion of any article desired to be secured, such as, for example, an umbrella, a beach umbrella, an event tent, a supermarket tent, a flag pole, a canopy, a sports goal, a sports net, a fence post, a sign post, a piece of furniture, a lamp and/or the like. The present disclosure should not be deemed as limited to a specific embodiment of the pole. It should be understood that the apparatus, the system, and/or the method may be used to hold any object desired to be held at any angle above a surface.

The tube 10 may be part of an apparatus and/or system for holding, stabilizing and/or securing the pole. The tube 10 may have a length defined between a first end 11 and a second end 12. The second end 12 may be positioned opposite to the first end 11. The first end 11 of the tube 10 may be affixed to the plate 20 and/or a top surface 21 thereof. The tube 10 may be affixed to the plate 20 using a weld, fasteners, cement, and/or any other way of conjoining two bodies that is known to one having ordinary skill in the art. The second end 12 of the tube 10 may have an opening 13 for accommodating a pole and/or a base of a pole therein. A fastener 14 may be provided on the tube 10 for affixing the pole into the tube 10. The fastener 14 may be a bolt, screw or other fastener that may be abutted against the pole. In an embodiment, the tube 10 may have a drainage aperture 15 for restricting, for example, water and/or other liquids from collecting inside the tube 10. The tube 10 may be constructed of metal, plastic, polyvinyl chloride (“PVC”), and/or any other rigid or semi-rigid material known to one having ordinary skill in the art. In embodiments in which the apparatus is constructed of metal, the plate 20, the tube 10, and the fins 25 may be welded together. If the apparatus is formed of plastic, the plate 20, the tube 10, and/or the fins 25 may be integrally molded.

The plate 20 may be relatively planar having a top surface 21 and a bottom surface 22 that may be positioned opposite to the top surface 21. The top surface 21 may be affixed to the first end 11 of the tube 10 using a weld, fasteners, cement, and/or any other way of conjoining two bodies that is known to one having ordinary skill in the art.

The bottom surface 22 of the plate 20 may have one or more fins 25 for anchoring the plate 20, the tube 10 and/or the pole. The fins 25 may extend from the bottom surface 22 of the plate 20. As shown, the fins 25 may be affixed perpendicularly to the bottom surface 22. Further, the fins 25 may be rectangular in an embodiment of the present disclosure. The fins 25 may be sized to fit in a crack, a crevice and/or a hole. Moreover, the fins 25 may sized to be pushed and/or driven into a loose surface.

In an embodiment, the fins 25 may be spaced according to the width of decking boards and/or other components of a structure. Thus, for example, the fins 25 may be spaced to fit between decking boards on a deck. Moreover, depending on the size of the pole, multiple fins 25 may be used to increase strength. The fins 25 may counter a moment force created by an object that may be supported by the pole. For example, an umbrella may exert a significant moment force at the base of the pole due to the length of the pole and forces acting upon the upper umbrella portion thereof.

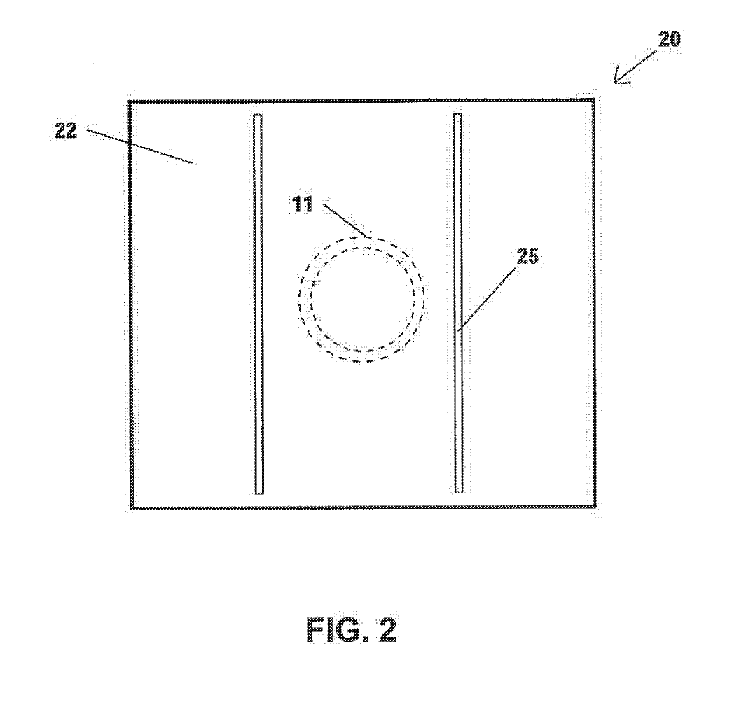

FIG. 2 illustrates a bottom view of the apparatus and/or the system shown in FIG. 1. As shown, the fins 25 are generally planar and may extend from the bottom surface 22 of the plate 20. In this embodiment, the plate 20 is uniform and has no apertures. The first end 11 of the tube 10 may rest atop the top surface 21 of the plate 20. Furthermore, the tube 10 may not extend through the plate. As shown, the cross section of the tube 10 may be circular; however, the tube 10 may be formed of any shaped cross-section depending on the application and/or use.

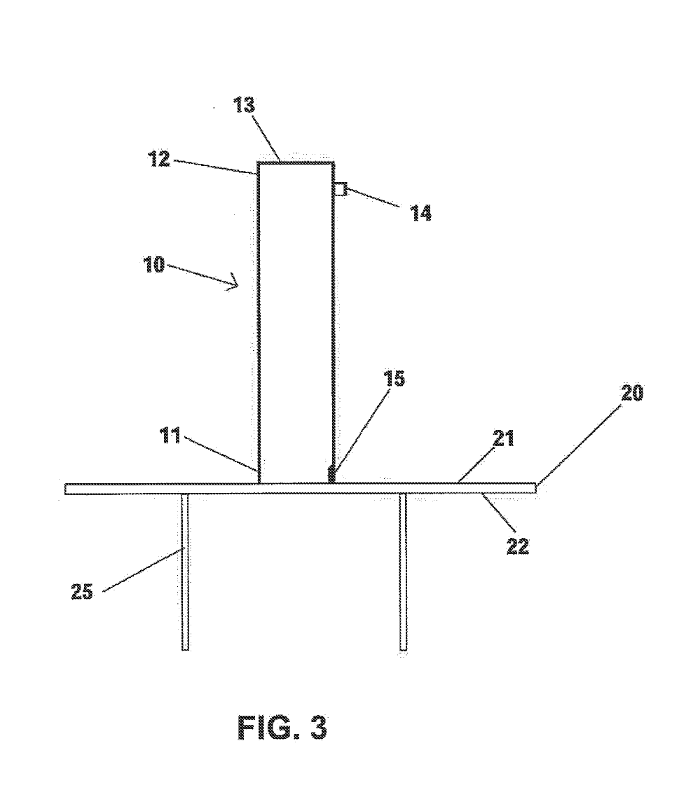

FIG. 3 illustrates a side elevation view of the apparatus and/or the system shown in FIG. 1. As shown, the fins 25 may be oriented perpendicularly to the plate 20. The fins 25 may be affixed to the bottom surface 22 of the plate 20 using a weld, fasteners, cement, and/or any other way of conjoining two bodies that may be known to one having ordinary skill in the art. As shown, the fastener 14 may extend from the tube 10. To receive the fastener 14, the tube 10 may have a threaded hole that extends to the inside of the tube 10. Alternatively, the pole may be secured into the tube 10 using a clamp, a push-button spring clip and/or any other fastening mechanism that may be known in the art.

In an embodiment, the apparatus may be constructed and/or may be used by providing a tube 10, a plate 20, and one or more rectangular sections to be used as fins 25. The tube 10 may be affixed to the top surface 21 of the plate 20, and the fins 25 may be affixed to the bottom surface 22 of the plate 20. The apparatus may be placed on a surface such that the fins 25 may penetrate the surface, and the bottom surface of the plate 20 may rest on the surface. The fins 25 may be placed between two or more boards of a deck structure. Alternatively, the fins 25 may be driven into a ground composed of loose particles, such as a lawn or beach, or inserted into slits formed in concrete, such as, for example, a sidewalk, pavers, a patio, or the like. In an embodiment, a wood and/or deck section (not shown) may be provided with the apparatus to reinforce the apparatus on any type of surface.

The length of the fins 25 may correspond to the use. For example, shorter and/or thinner fins 25 may be used for installing the apparatus on a surface composed of pavers and/or patio stones. In this embodiment, the fins 25 may be spaced to correspond to joints between pavers. The fins 25 may penetrate a grout between the paver stones. Alternatively, the grout may be removed from a joint before the apparatus is installed. In still another embodiment, the fins 25 may be pressed to penetrate a grass and/or lawn surface. The fins 25 may be a certain sharpness and/or strength to bore into a lawn and/or grass surface. Alternatively, slits may be cut into the lawn and/or grass surface prior to installing the apparatus on the surface. A user may, for example, step on the top surface 21 of the plate 20 to drive the fins 25 into the ground. With the plate 20 resting on the surface, a base of a pole may be inserted into the opening 13 of the tube 10. The fastener 14 may abut the pole to secure the pole in the tube 10.

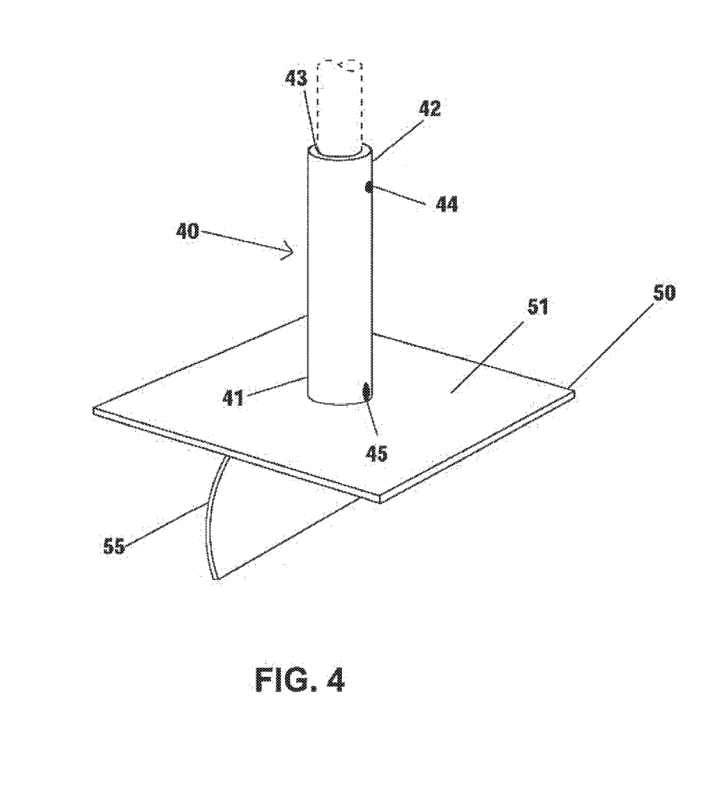

FIG. 4 illustrates a perspective view of an apparatus and/or a system for holding a pole using a curved fin in an embodiment of the present disclosure. As shown, the apparatus and/or system may have a tube 40 and a plate 50. The tube 40 may be part of an apparatus and/or system for holding, stabilizing and/or securing the pole. The tube 40 may have a length defined between a first end 41 and a second end 42 that may be positioned opposite to the first end 41. The first end 41 of the tube 40 may be affixed to the plate 50 and/or a top surface 51 of the plate 50. The tube 40 may be affixed to the plate 50 using a weld, fasteners, cement, and/or any other way of conjoining two bodies that is known to one having ordinary skill in the art. The second end 42 of the tube 40 may have an opening 43 for accommodating a pole and/or a base of a pole therein. As shown, the pole may rest within the interior of the tube 40. A hole 44 may be provided on the tube 40 for affixing the pole into the tube 40 using a fastener. The hole 44 may be threaded to accommodate a screw and/or a bolt. In an embodiment, the tube 40 may have a drainage aperture 45 for restricting liquids from collecting inside the tube 40. The tube 40 may be constructed of metal, plastic, PVC, and/or any other rigid or semi-rigid material known to one having ordinary skill in the art.

The plate 50 may be relatively planar having a top surface 51 and a bottom surface 52 that may be positioned opposite to the top surface 51. The top surface 51 of the plate 50 may support the tube 40. The top surface 51 may be affixed to the first end 41 of the tube 40 using, for example, a weld, fasteners, cement, and/or any other way of conjoining two bodies that is known to one having ordinary skill in the art.

As shown, the bottom surface 52 of the plate 50 may have a curved fin 55 that may anchor the plate 50, the tube 40 and/or the pole. The curved fin 55 may be a thin rectangular section with a curvature. The curved fin 55 may be of any radius of curvature and/or central angle. The curved fin 55 may retain the plate 50 in a given position by resisting a vertical force and/or a horizontal force acting on the plate 50, the tube 40, and/or the pole. The curvature of the curved fin 55 may act to cradle, for example, a decking board of a deck. Thus, an upward force acting upon the apparatus is resisted by the curved fin 55 due to the curved fin 55 being under the surface.

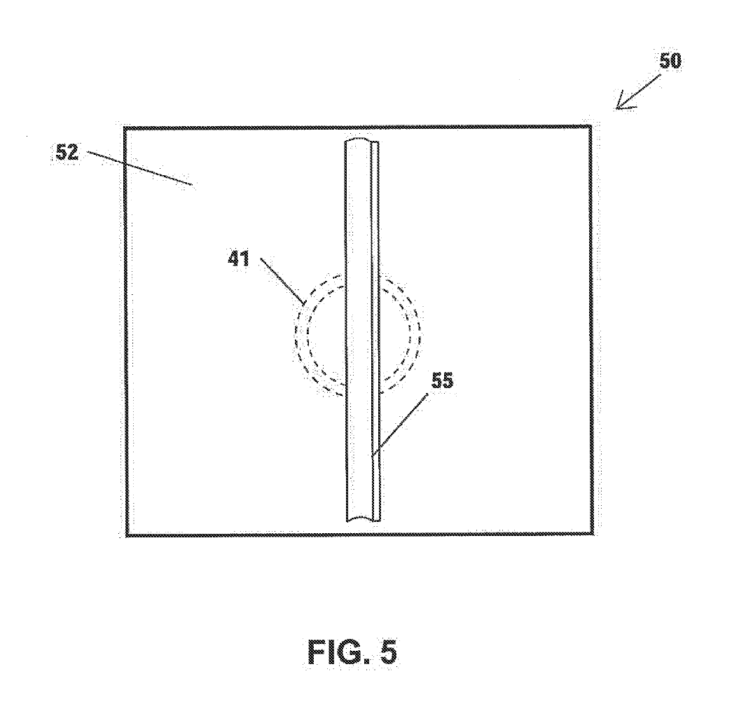

FIG. 5 illustrates a bottom plan view of the apparatus and/or the system shown in FIG. 4. As shown, the apparatus may have one curved fin 55 extending from a bottom surface 52 of the plate 50. The width of the fin 55 may not extend to the edges of the plate 50 to give a minimalistic aesthetic quality to the apparatus. Although the fin 55 in FIG. 4 and FIG. 5 has a uniform curvature, it should be recognized that the fin 55 may have any type of curvature and/or bending. For example, the fin may have an S-type curvature or an L-type curvature. Different curvatures may be appropriate for differing surfaces and/or different applications of the apparatus and/or the system.

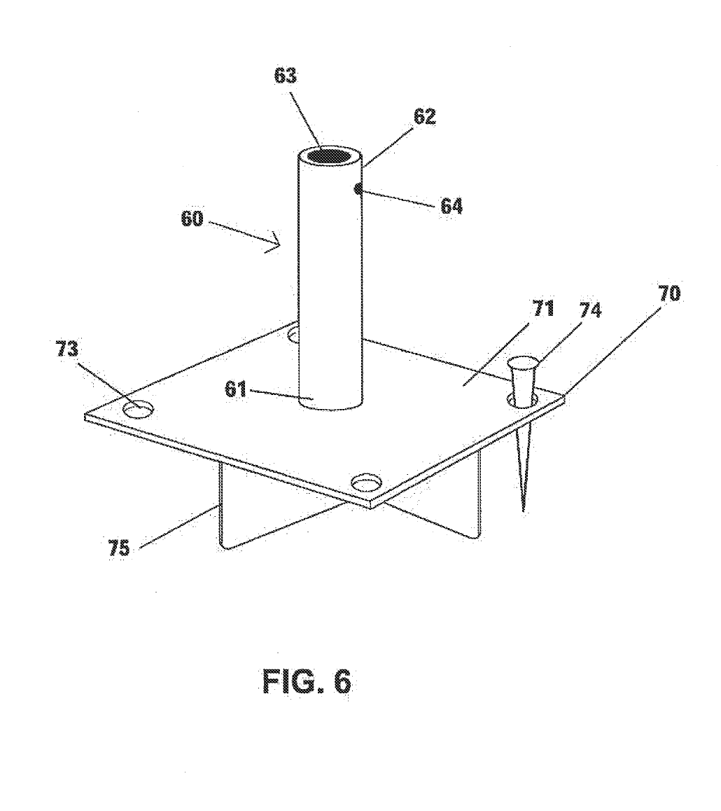

FIG. 6 illustrates a perspective view of an apparatus and/or a system for holding a pole in and/or on a surface composed of loose particles. As shown, the apparatus and/or system has a tube 60 and a plate 70. The tube 60 may have a length defined between a first end 61 and a second end 62 that may be positioned opposite to the first end 61. The first end 61 of the tube 60 may be affixed to the plate 70 and/or a top surface thereof 71. The tube 60 may be affixed to the plate 70 using a weld, fasteners, cement, and/or any other way of conjoining two bodies that is known to one having ordinary skill in the art. The second end 62 of the tube 60 may have an opening 63 that may accommodate a pole and/or a base of a pole therein. A hole 64 may be provided on the tube for affixing the pole into the tube 60 using a fastener. The hole 64 may be threaded to accommodate a screw and/or a bolt. The tube 60 may he constructed of PVC, metal, plastic, and/or any other rigid or semi-rigid material known to one having ordinary skill in the art.

The plate 70 may be relatively planar having a top surface 71 and a bottom surface 72 that may be positioned opposite to the top surface 71. The top surface 71 of the plate 70 may support the tube 60. The top surface 71 may be affixed to the first end 61 of the tube 60 using a weld, fasteners, cement, and/or any other way of conjoining two bodies that is known to one having ordinary skill in the art.

As shown in FIG. 6, the plate 70 may have one or more holes 73. The holes 73 may be located near corners of the plate 70. The holes 73 may be used for stakes 74 and/or nails, bolts, pegs and the like to extend through the holes 73 and into the ground and/or surface to hold the plate 70. The stakes 74 may be used in addition to the fins 75 for securing the plate 70, the tube 60, and/or the pole. The embodiment shown may be suited for use on a surface that is composed of loose particles, such as sand, gravel, shingle, pebbles, dirt, and/or grass.

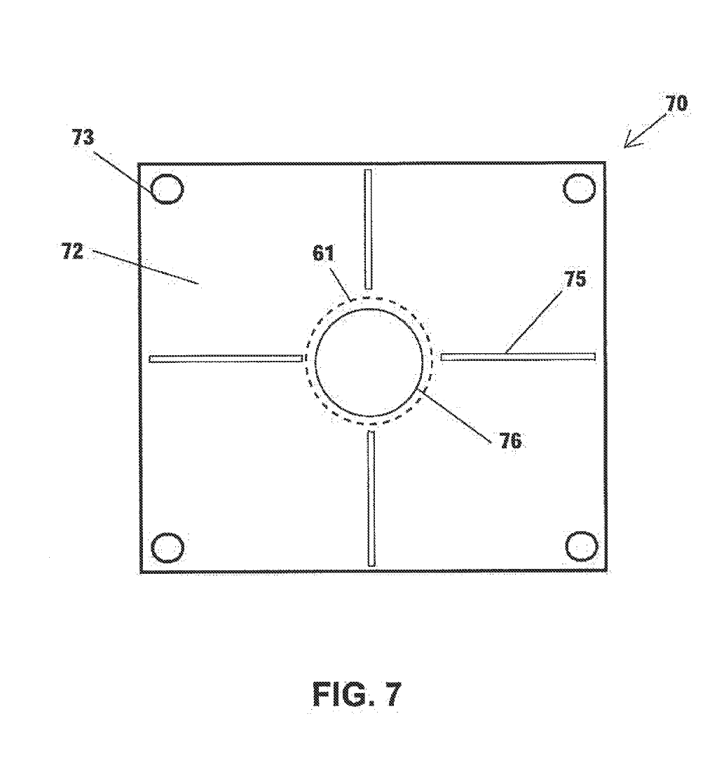

FIG. 7 illustrates a bottom plan view of the apparatus and/or the system shown in FIG. 6. As shown, the bottom surface 72 of the plate 70 may have two or more fins 75 for anchoring the plate 70, the tube 60 and/or the pole. The fins 75 may be rectangular and may have curved corners to facilitate a bore into a surface. The fins 75 may be arranged in an X-shape configuration or a cross-shape configuration.

As shown, the tube 60 may extend through a hole in the plate 70. Thus, the plate 70 may have an aperture 76 through which the pole may extend. In this embodiment, a base of the pole may extend through the apparatus and/or into the surface. Therefore, the pole may also contribute to stabilizing itself, the plate 70, and/or the tube 60. The fins 75, the pole, and/or the stakes may anchor the apparatus of the present embodiment. As shown, the fins 75 may be arranged such that the aperture 76 is unobstructed. Moreover, the pole (not shown) may extend freely through the aperture 76.

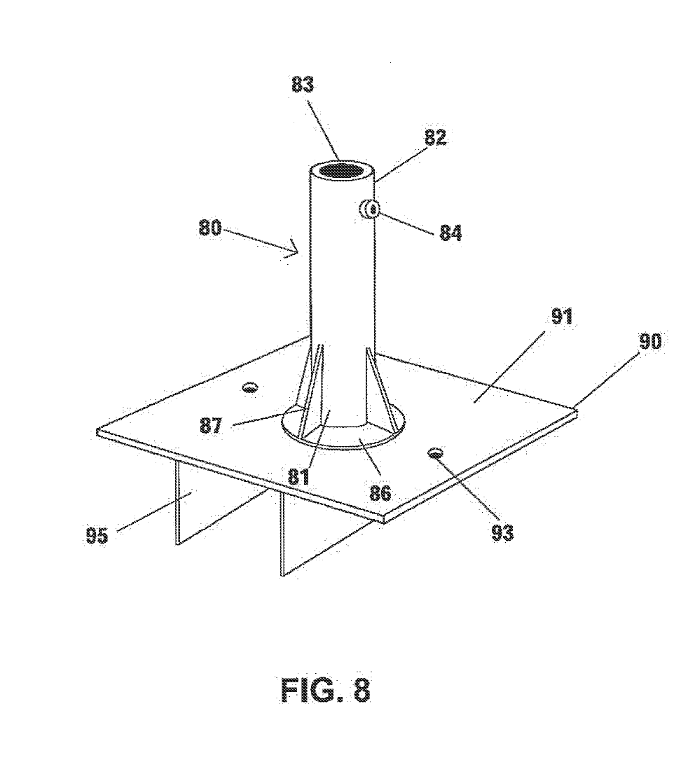

FIG. 8 illustrates a perspective view of an apparatus and/or system for holding a pole in another embodiment of the present disclosure. As shown, the apparatus and/or system has a tube 80 and an plate 90. The tube 80 may have a length defined between a first end 81 and a second end 82 that may be positioned opposite to the first end 81. The first end 81 of the tube 80 may be affixed to the plate 90 and/or a top surface 91 of the plate 90. The second end 82 of the tube 80 may have an opening 83 for accommodating a pole and/or a base of a pole therein. A fastener 84 may be provided on the tube for affixing the pole into the tube 80. The tube 80 may be constructed of PVC, metal, plastic, and/or any other rigid or semi-rigid material known in the art.

The plate 90 may be relatively planar having a top surface 91 and a bottom surface 92 that may be positioned opposite to the top surface 91. As shown, the plate 90 may have one or more holes 93. The holes 93 may be used for driving stakes 74 into the ground and/or surface for securing the plate 90. The stakes 74 may be used in addition to any fins 95 for securing the plate 90, the tube 80, and/or the pole. The plate 90 may also have one or more fins 95 extending therefrom for anchoring the apparatus onto a surface. The embodiment shown may be suited for use on a surface that is composed of loose particles, such as sand, gravel, shingle, pebbles, dirt, and/or grass.

As shown, the tube 80 may be affixed to the plate 90 using an anchor flange 86. The anchor flange 86 may be affixed to the top surface 91 of the plate 90 using a weld, fasteners, cement, and/or any other way of conjoining two bodies that is known in the art. One or more diagonal stays 87 may be affixed between the side of the tube 80 and the anchor flange 86. The stays 87 may further strengthen and/or stabilize the juncture of the tube 80 and the plate 90. The anchor flange 86 provides a larger surface area with which the tube 80 may be affixed to the plate 90.

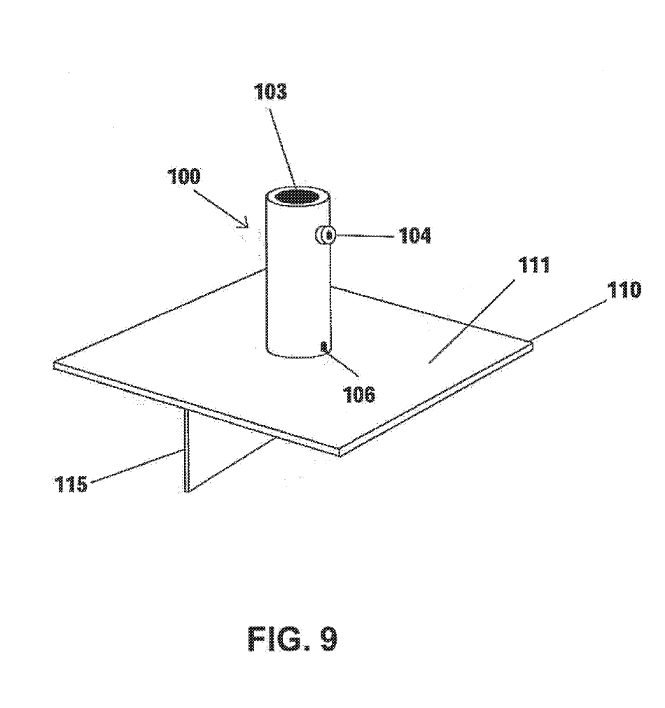

FIG. 9 illustrates a perspective view of an apparatus and/or system for holding a pole in another embodiment of the present disclosure. In this embodiment, a single fin 115 may extend from the plate 110. As shown, the tube 100 may have a shorter height than shown in previous embodiments. Likewise, the plate 110 may be thinner. Further, plate 110 may have a top surface 111. Tube 100 may have an opening 103 and a fastener 104 for affixing the pole in the tube 100. The fastener 104 may be threaded to accommodate a screw and/or a bolt. The tube 100 may have a drainage aperture 106 for restricting liquids from collecting inside the tube 40. The tube 100 may be constructed of metal and/or any other rigid or semi-rigid material known to one having ordinary skill in the art. In this embodiment, the apparatus may be light-weight due to the smaller tube size and/or an integrally molded construction. The apparatus may be fabricated as a single piece of molded plastic or metal to reduce weight.

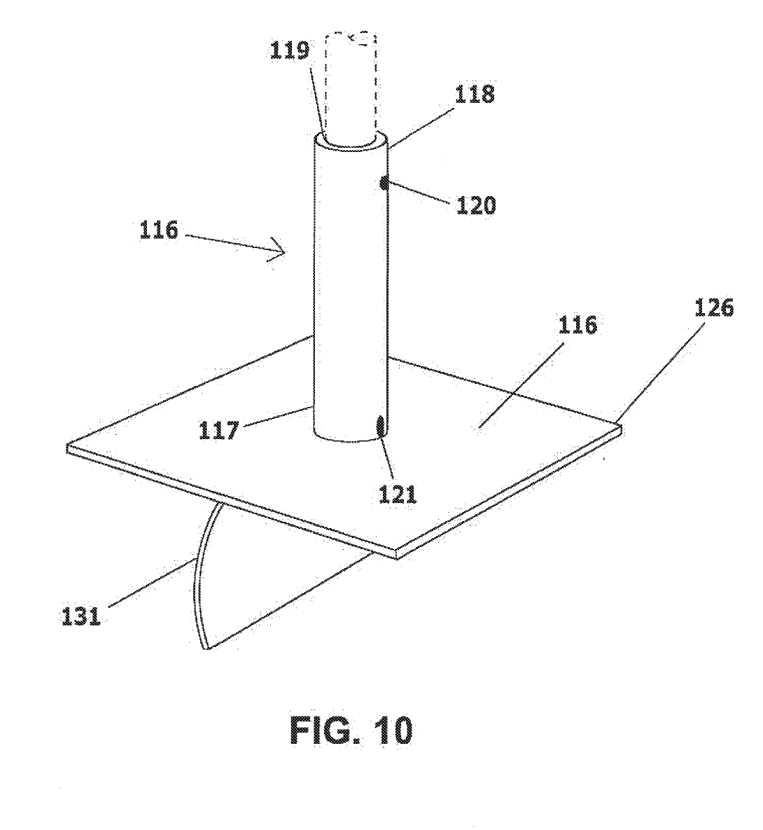

FIG. 10 illustrates a perspective view of an apparatus for holding a pole in another embodiment of the present disclosure. In this embodiment, the apparatus and/or system may have a tube 116 affixed to a plate 126. The plate 126 may have an a single fin 131 curved about the vertical axis for anchoring the plate, the tube, and/or the pole onto and/or into a surface. The curvature of the fin 131 may vary in angle and is not limited to that illustrated by FIG. 10. The fin 131 may be flexible.

The curvature of fin 131 may assist in improving the overall stability of the apparatus by restricting unwanted movement of the apparatus, especially in loosely-held surfaces such as damp ground and/or sand. The fin 131 may dig into such loosely-held surfaces to counter a moment force created by an object that may be supported by the pole. For instance, an umbrella may sway in response to strong winds and thus exert a moment force at the base of the pole via the length of the pole. The fin 131 may stabilize the apparatus such that additional weight plates to weigh upon the plate 126 are not necessary. Weight plates may be made from cast iron that may be prone to rust where the rust may discolor the deck surface, for example, upon which the apparatus is placed.

As shown in FIG. 10, the tube 116 may be part of an apparatus and/or system for holding, stabilizing and/or securing the pole. The tube 116 may have a first end 117 and a second end 118 where the first end 117 may be positioned opposite to the second end 118. The second end of the tube 118 may have an opening 119 for accommodating a pole and/or a base of a pole therein. A hole 120 may be provided on the tube 116 for affixing the pole into the tube 116 using a fastener that may be inserted into the hole 120 and abutted against the pole. Further, the tube 116 may have a drainage aperture 121 for restricting liquids from collecting inside the tube 116. The tube 116 may be constructed of metal and/or any other rigid or semi-rigid material known to one having ordinary skill in the art. Further, the apparatus may be painted in various colors to coordinate with the umbrella and/or other items.

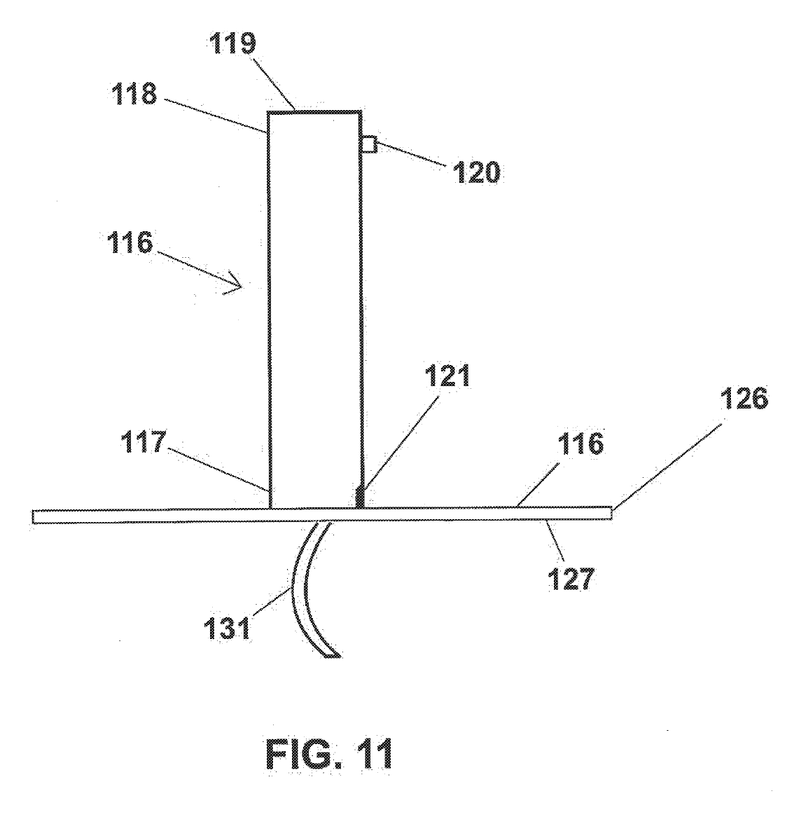

FIG. 11 illustrates a side view of the apparatus and/or the system shown in FIG. 10. As shown, the fin 131 may be oriented to attach to and protrude from plate 126. Fin 131 curves about an axis perpendicular to the tube 116. The curvature of fin 131 may include other angles not shown in FIG. 11. The curvature of fin 131 may enhance the ability of the fin 131 to penetrate into a loosely-held surface such as soft ground and/or sand, for example. Also, the curvature of fin 131 may improve ability of the fin 131 to adhere to loosely-held surfaces such as sand and/or dirt, for example, since the amount of force exerted on the fin by sand or dirt particles, for example, will vary by position relative to the fin. Thus, when compared against a traditional straight vertical fin, the fin 131 may restrict movement of the fin 131 and the apparatus by better biting into the surface into which the fin 131 is inserted. Further, enhanced gripping characteristics of the fin 131 may be useful in restricting movement of the apparatus in instances of inclement weather such as strong wind.

Alternatively, the fin 131 may be inserted in the crack or crevice formed between adjacent floor beams on a deck. The fin 131 may be of a flexible construction to squeeze into the crack or crevice and later expand so as to allow the apparatus to which the fin 131 is attached to sit flush on the deck. Additionally, in an embodiment, the apparatus with fin 131 may support and/or otherwise accommodate umbrellas up to and including eleven feet in diameter, for example.

The fin 131 may be affixed to the bottom surface 127 of the plate 126 using any way of conjoining two bodies that may be known to one having ordinary skill in the art. As shown, the hole 120 may have interior threads that extend through to the inside of the tube 116. The hole 120 may accommodate a fastener, such as those set forth above. Alternatively, a pole may be secured into the tube 116 using a clamp and/or any other fastening mechanism that may be known in the art.

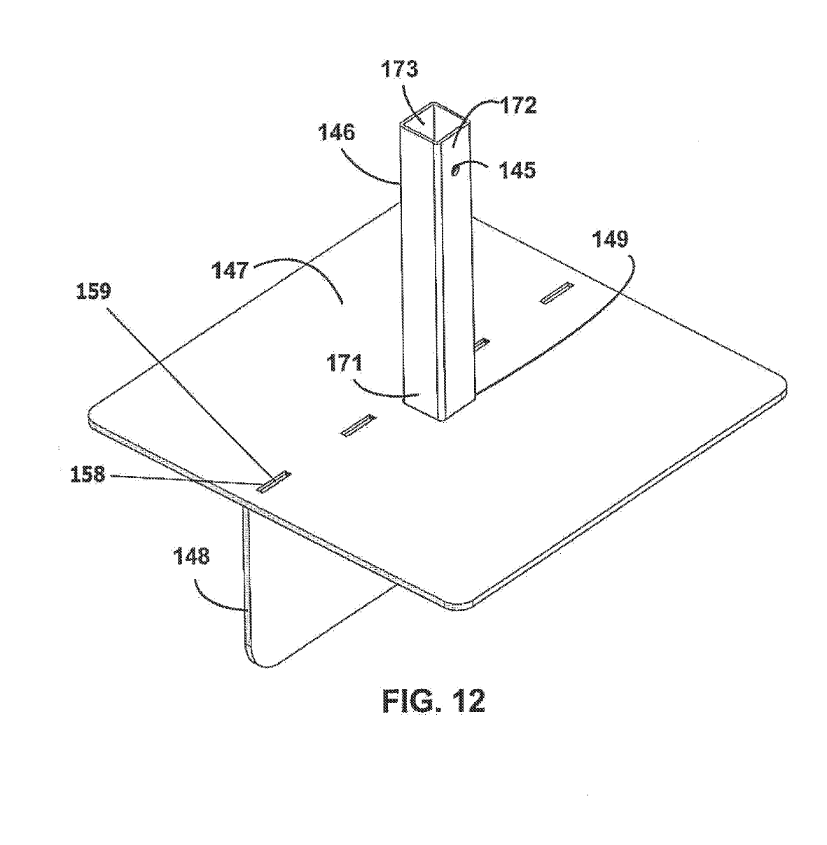

FIG. 12 illustrates a perspective view of an apparatus and/or system for holding a pole in another embodiment of the present disclosure. As shown, the apparatus and/or system has a tube 146 and a plate 147. The tube 146 may have a length extending between a first end 171 and a second end 172. The first end 171 of the tube 146 may be affixed to the plate 147. The, second end 172 of the tube 146 may have an opening 173 for accommodating a pole and/or a base of a pole therein. A hole 145 may be provided on the tube for affixing the pole into the tube 146 using a fastener as disclosed above. The hole 145 may be threaded to accommodate a screw and/or a bolt. The tube 146 may be constructed of PVC, metal, plastic, and/or any other rigid or semi-rigid material known in the art.

A substantially rectangular fin 148 is attached to and protrudes outward from the plate 147 at a perpendicular angle. As shown in the embodiment of FIG. 12, the plate 147 may have slots 158. The fin 148 may have corresponding tabs 159 that fit into the slots 158 in the plate 147 to secure the fin 148 to the plate 147. The attachment of the fin 148 to the plate 147 using the slots 158 and the tabs 159 may allow for easier assembly and disassembly of the apparatus and/or system.

The fin 148 may provide additional stability and/or support for the apparatus to accommodate equipment that may be larger than a traditional recreational beach umbrella such as a canopy tent. Canopy tents may be used with portable shelters and canopies for sporting events, exhibit booths, weddings and other various events. Accordingly, canopy tents may be heavier than beach umbrellas and thus may require additional support to maintain stability. The size of the fin 148 may allow for further penetration into a surface such as soil, gravel and/or sand. Deeper penetration of the fin 148 into a surface may improve the stability of the apparatus by more substantially anchoring the apparatus to the surface into which the fin 148 penetrates. Accordingly, the embodiment shown may be suited for use on surfaces composed of loosely-held particles and may further anchor the apparatus to restrict movement of the apparatus resultant from inclement weather conditions such as, for example, strong wind. Further, the embodiment shown may offer stability for the apparatus without any need for concrete buckets, tie downs, stakes and/or any other improvised methods to hold a canopy tent in place. Although sturdy and robust, the embodiment may be suited to be light-weight and portable as well.

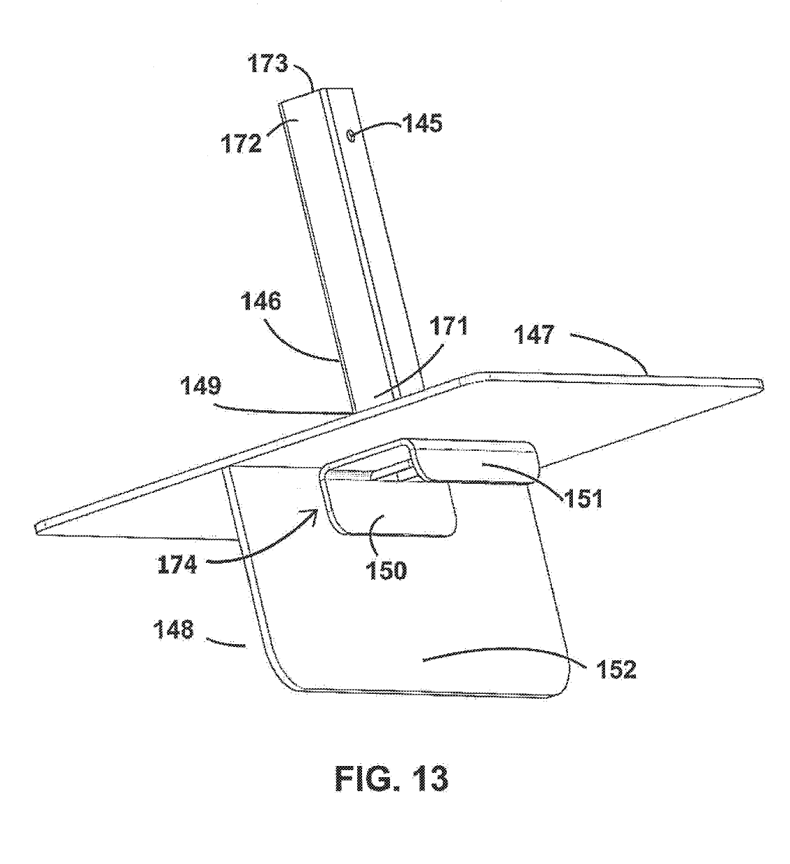

FIG. 13 shows another perspective view of the embodiment of the apparatus and/or system shown in FIG. 12. The second end 172 of the tube 146 may be inserted vertically through an opening 149 in the plate 147. An anchor plate 174 may have a longer section 150 adjacent to the fin 152 and a shorter section 151 may be oriented in parallel to a surface 152 of the fin 148. The anchor plate 174 may assist in further stabilizing the tube 146 to the apparatus and to further anchor the apparatus to a loosely-held surface, such as, for example, soft ground, soil, gravel and/or sand. Also, the longer section 150 and the shorter section 151 may act as additional fins for securing the apparatus to a surface.

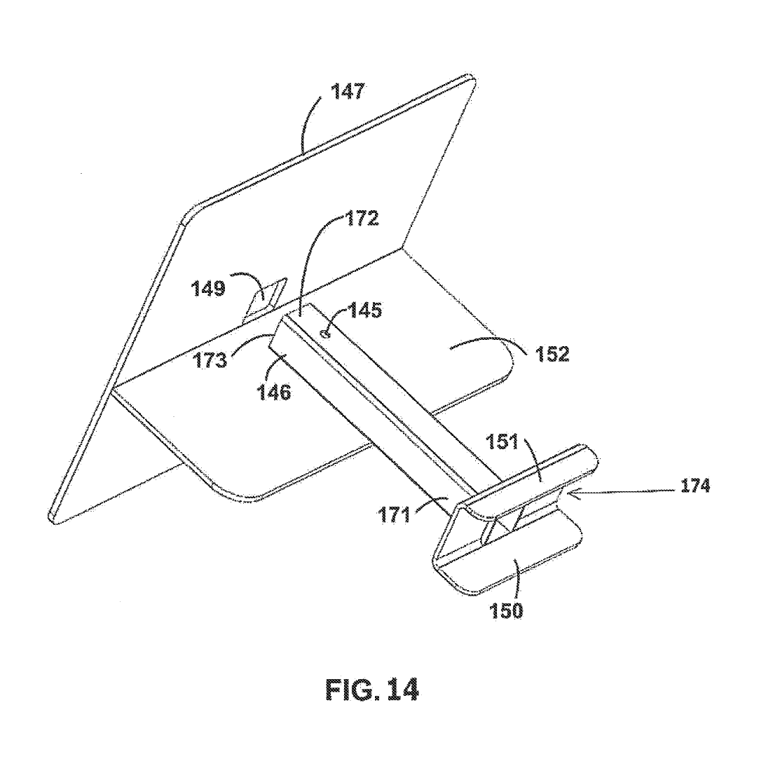

FIG. 14 shows another perspective view of the embodiment of the apparatus and/or system shown in FIG. 12. The tube 146 having a first end 171 and a second end 172 may have the second end 172 inserted vertically through the opening 149 in the plate 147. As shown, the tube 146 may be inserted or removed from the opening 149 of the plate 147 for assembly or disassembly, respectively. The anchor plate 174 having a longer section 150 and a shorter section 151 may be attached to the tube 146 and follow the tube 146 upwards toward the plate 147 to press against an underside surface of the plate 147. The location of the anchor plate 174 beneath the plate 147 may further stabilize the tube 146 and/or the apparatus as a whole.

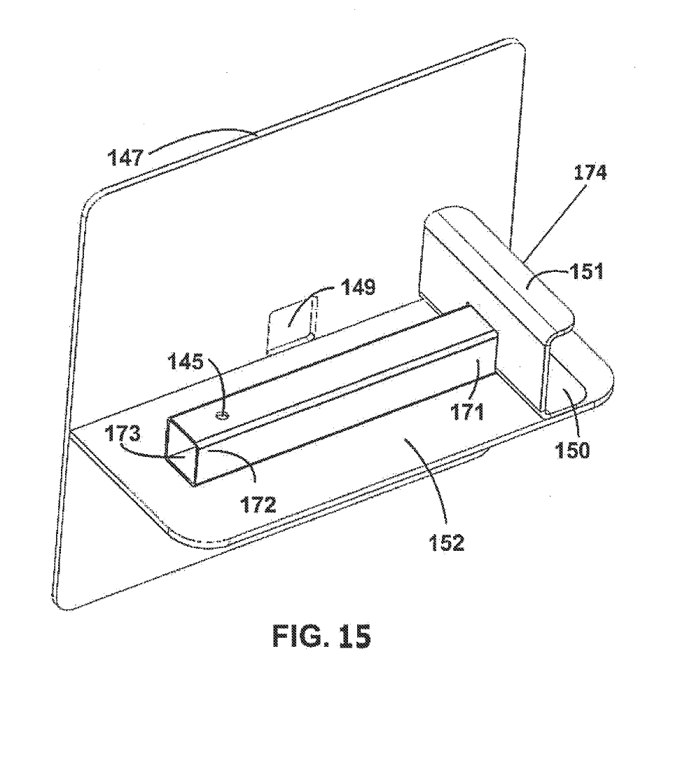

FIG. 15 shows another perspective view of the embodiment of the apparatus and/or system shown in FIG. 12 with the tube placed on a surface 152 of the fin 148 to provide a further illustration of the approximate dimensions that may be associated with this embodiment. Also, FIG. 15 shows how the tube 146 may be stored with the plate 147 when disassembled.

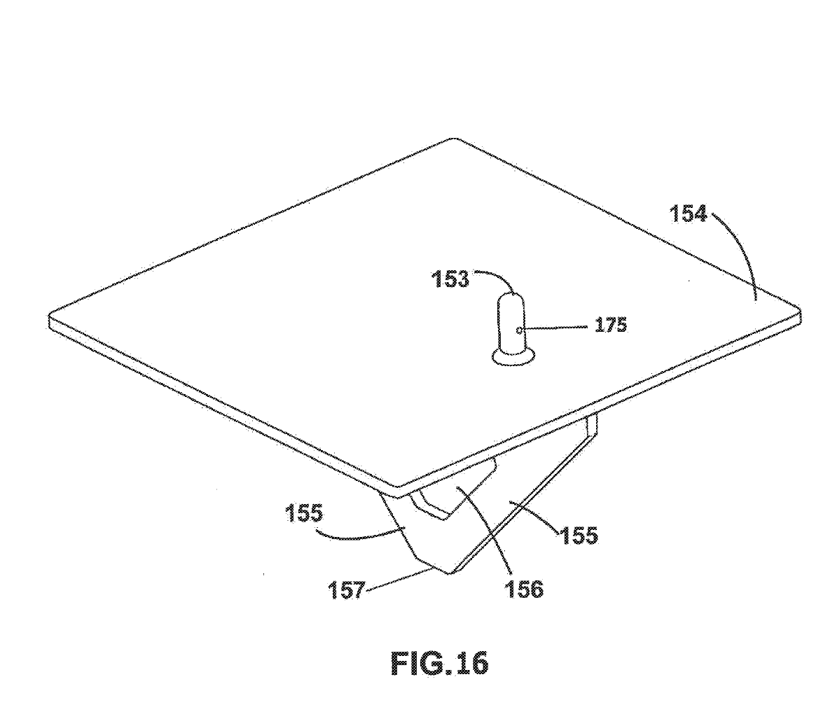

FIG. 16 illustrates a perspective view of an apparatus and/or system for holding a pole in another embodiment of the present disclosure. As shown, the apparatus and/or system has a substantially triangularly-shaped fin 157 with a cut-out portion 156 and two side portions 155 that join together to form a tip of the triangularly-shaped fin 157. The triangularly-shaped fin 157 may be used in conjunction with canopy tents which are often heavier than traditional recreational umbrellas. Accordingly, canopy tents may require a more robust stabilization apparatus as shown by the embodiment presented in FIG. 16. The side portions 155 of the triangularly-shaped fin 157 may push, for example, soft ground, gravel, mud or sand aside as the triangularly-shaped fin 157 penetrates deeper into such loosely-held surfaces. Also, soft ground, gravel, mud, sand and/or any other loosely-held surface material may fill into the cavity formed by the cut-out portion 156 to envelop the triangularly-shaped fin 157 and thus provide additional stability. The stability may be useful and/or beneficial in applications of the apparatus to hold canopy tents where canopy tents, due to their size and general bulk, may be especially susceptible to unwanted movement in response to inclement weather conditions, such as, for example, strong winds.

The apparatus and/or system has a substantially flat plate 154 on which a knob 153 is affixed. The knob 153 may have a hole 175. Further, the plate 154, the knob 153 and the substantially triangularly-shaped fin 157 may be constructed of PVC, metal, plastic, and/or any other rigid or semi-rigid material known in the art.

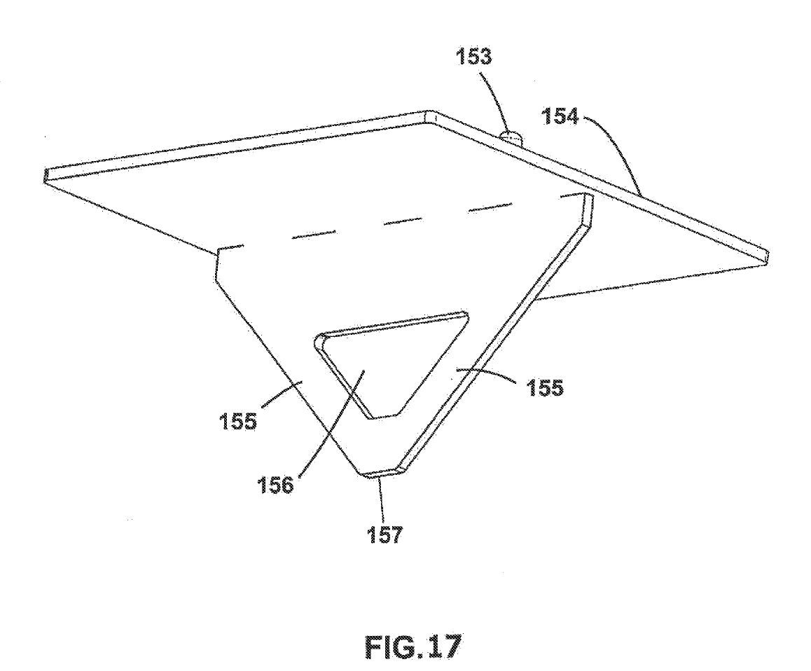

FIG. 17 illustrates another perspective view of the apparatus and/or system shown in FIG. 16. As shown, the triangularly-shaped fin 157 extends from the plate 154 at a perpendicular angle. The triangularly-shaped fin 157 may be affixed to the plate 154 using any way of conjoining two bodies that may be known to one having ordinary skill in the art. The approximate dimensions shown in FIG. 17 are not to be construed to limit the embodiment. For instance, the triangularly-shaped fin 157 may extend further away from the plate 154 and the cut-out portion 156 may be smaller than that shown in FIG. 17.

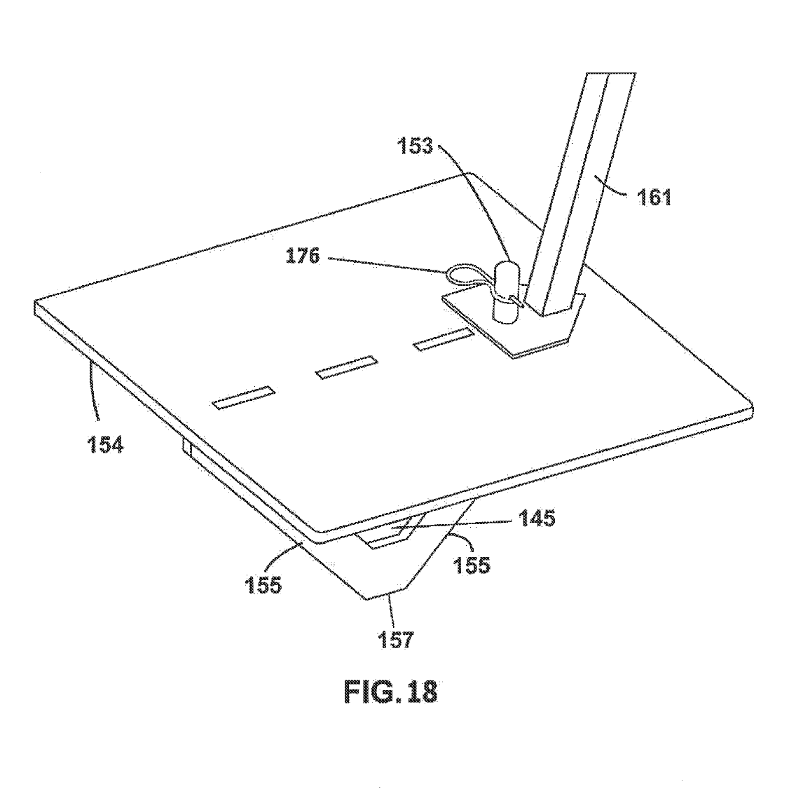

FIG. 18 shows a perspective view of the apparatus and/or system shown in FIG. 16. As shown, the knob 153 on the plate 154 may have a cotter pin 176 that extends through the hole 175 in the knob 153. The cotter pin 176 may assist in securing a tube 161 to the plate 154 to accommodate a pole. Other devices known to one having ordinary skill in the art may be used instead of the cotter pin 176.

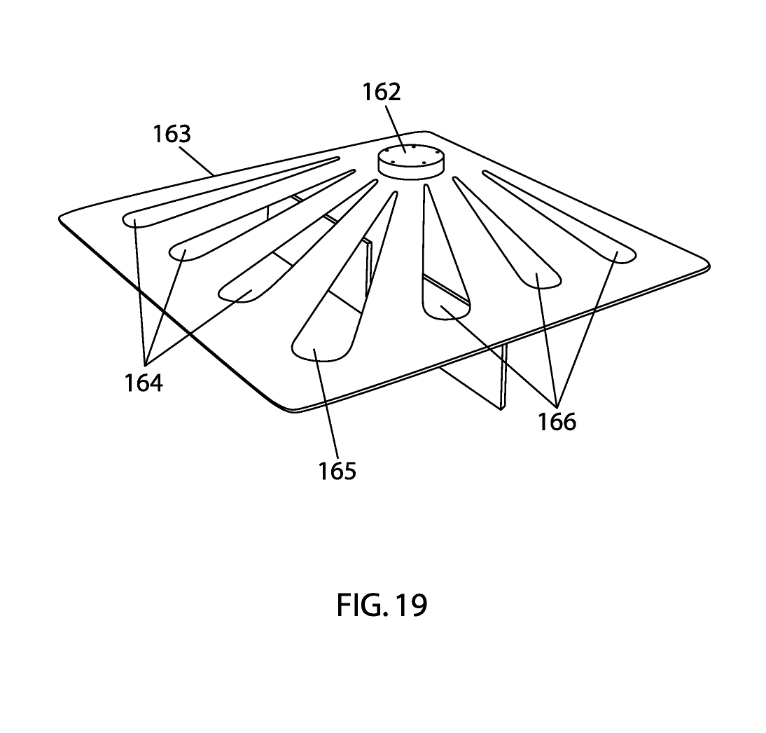

FIG. 19 illustrates a perspective view of an apparatus and/or system for holding a pole in another embodiment of the present disclosure. As shown, the apparatus and/or system has a plate 163 from which a first set of sections 164 a second set of sections 166 and a center diagonal section are cut out from the plate 163. Further, the plate 163 may have a stub 162 that may be used to mount a tube into which a pole may be inserted, for example. The plate 163 may be constructed of PVC, metal, plastic, and/or any other rigid or semi-rigid material known in the art. The cut-out sections 164, 165 and 166 of the plate 163 may allow for stakes and/or other objects to be driven through the cut-out sections 164, 165 and/or 166 to further hold, attach and/or otherwise stabilize the plate 163. Alternatively, the apparatus and/or system may be used without any stakes and/or other objects used to further secure the plate 163 to the surface on which the plate 163 sits and/or to which it attaches. Thus, this configuration may accommodate a patio made of, for example a hard surface such as concrete.

The embodiment shown by FIG. 19 may be particularly suited for cantilever type umbrellas where, for example, an umbrella may hang from an assembly rather than being supported directly by a pole. The size of the plate 163 may assist in further stabilizing a cantilever type umbrella where a larger plate may accommodate the additional stability requirements of larger cantilever umbrellas.

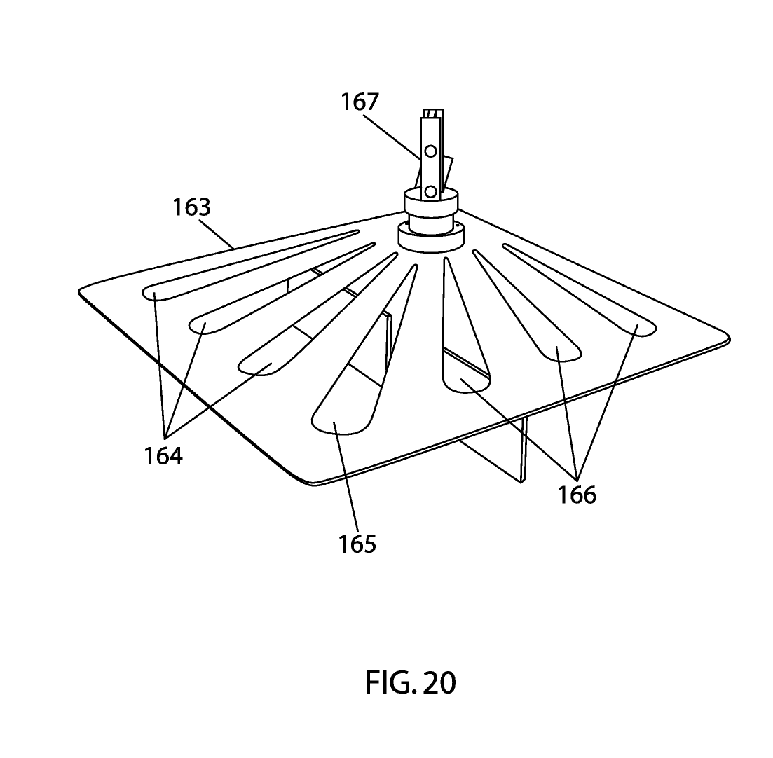

FIG. 20 illustrates another perspective view of an apparatus and/or system shown in FIG. 19. As shown, an attachment 167 may be affixed to the stub 162 (shown in FIG. 19) to mount and/or otherwise accommodate a tube into which a pole for a cantilever umbrella may be inserted.

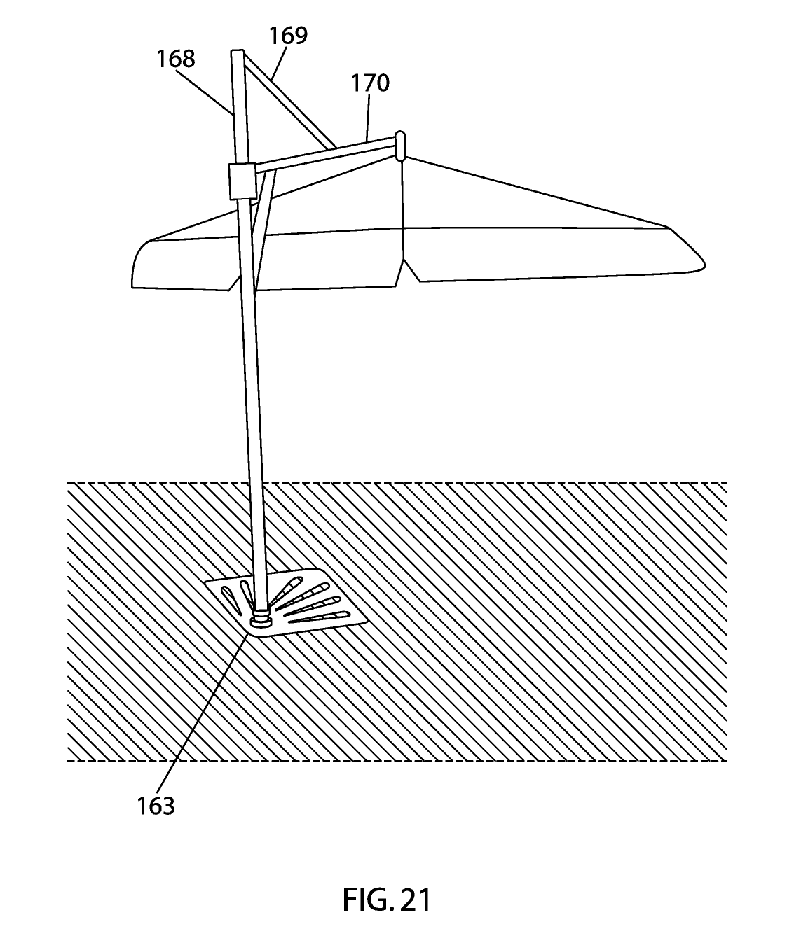

FIG. 21 illustrates a view of an apparatus and/or system shown in FIG. 19 where the apparatus and/or system is placed in an outdoor setting. As shown, the plate 163 may accommodate a tube via the attachment 167 (shown in FIG. 20) affixed to the stub 162 (shown in FIG. 19) that holds a pole 168. A support arm 169 hingedly connects to the pole 168 and swivels downward to attach to and/otherwise connect to an extender arm 170 to which the umbrella connects. Thus, the umbrella is suspended from the extender arm 170 rather than being supported by the pole 168. Further, the support arm 169 provides stability in instances in which the cantilever umbrella may face inclement weather conditions, such as, for example, strong winds. In the instance of strong winds, the umbrella portion of the cantilever umbrella may catch the wind and thus exert a force on the remainder of the apparatus. The plate 163 may be sized appropriately to provide sufficient stability to the pole 168 to restrict unwanted movement of the apparatus. Additionally, the plate 163 may be further secured to a ground surface by driving stakes, studs and/or the like through the cut-out sections to adhere the plate 163 to the ground surface.

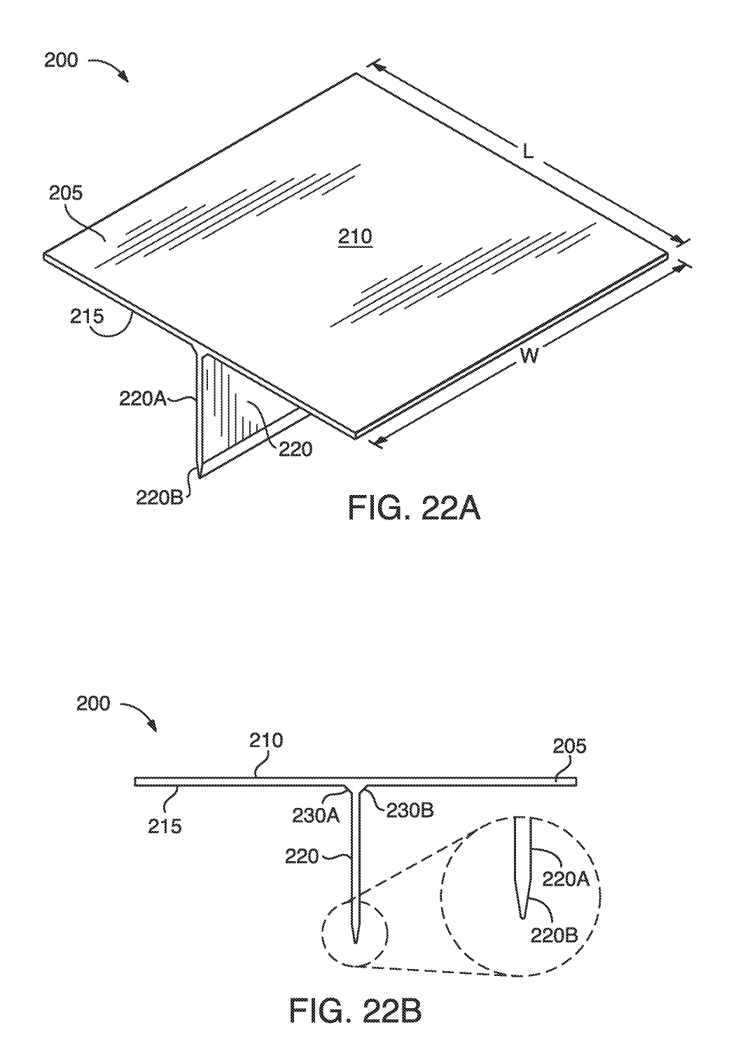

Turning now to FIGS. 22A and 22B, an embodiment of the present disclosure provides an apparatus 200 comprising a plate 205 having a top surface 210, a bottom surface 215, a length L and a width W. The apparatus 200 further comprises a fin 220, which in the embodiment shown extends substantially the entire width of the plate 205. The fin 220 comprises a body portion 220A and a beveled edge portion 220B. In the embodiment shown, the body portion 220A has a substantially uniform thickness, while beveled edge portion 220B has a thickness that narrows or tapers away from the plate 205. In some embodiments, beveled edge portion 220B tapers completely or substantially completely to form an edge having inconsequential width. In other embodiments, beveled edge portion 220B tapers incompletely so as to form an edge having a measurable width. In the embodiment shown in FIG. 22B beveled edge portion 220B tapers incompletely so as to form a rounded or beaded edge having a measurable width.

In some embodiments, the apparatus 200 has a length L and a width W that are substantially similar, or are the same. In some embodiments, length L is greater than width W. In some embodiments, length L is less than width W. In some embodiments, the apparatus 200 further comprises reinforcing structures 230A and/or 230B at or near the intersection of the bottom surface 215 and the fin 220. In some embodiments, the plate 205 and the fin 220 are integrally formed. In some embodiments, the plate 205, the fin 220 and the reinforcing structures 230A and/or 230B are integrally formed. In some embodiments, apparatus 200 further comprises a drain aperture (not shown). In some embodiments, the drain aperture is positioned in the plate 205 such that an affixed pole (not shown) surrounds or substantially surrounds the drain aperture to allow water or other fluid to drain from inside the pole through the plate 205. In some embodiments, the drain aperture is positioned in the plate 205 such that it is substantially out of alignment with the fin 220.

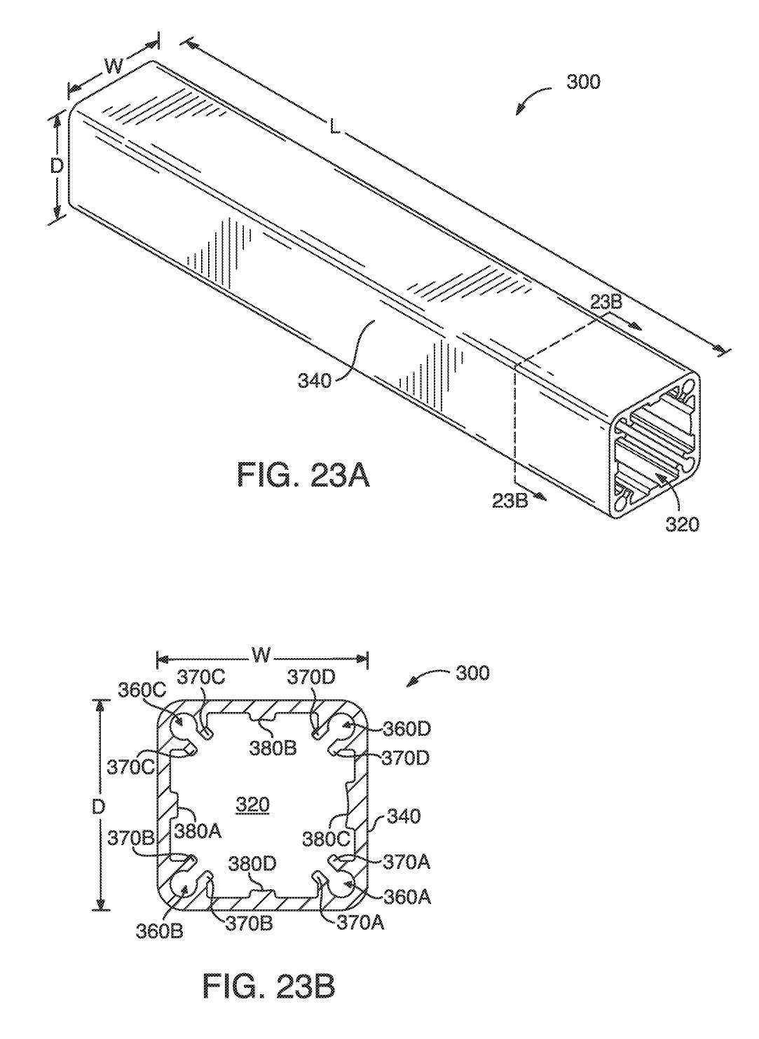

Referring now to FIGS. 23A and 23B, the present disclosure provides a pole 300 suitable for use with any embodiment disclosed herein, including any and all embodiments in which a pole having a different cross-sectional shape is illustrated or described. Pole 300 comprises an outer surface 340, an inner cavity 320, a length L, a width W and a depth D.

In some embodiments, the pole 300 has a polygon cross-sectional shape, such as a closed polygon, an equiangular polygon, a cyclic polygon, an isogonal polygon, an equilateral polygon, an isotoxal polygon, a tangential polygon, a rounded polygon, or a regular polygon. In some embodiments, the pole 300 has a polygon cross-sectional shape selected from the group consisting of: a triangle, a quadrilateral, a pentagon, a hexagon, a heptagon, an octagon, a nonagon, a decagon, a hendecagon, a dodecagon, a tridecagon, a tetradecagon, a pentadecagon, a hexadecagon, a heptadecagon, an octadecagon, an enneadecagon, or an icosagon. In other embodiments, the pole 300 has a cross-sectional shape of a circle, an oval, an ellipse, a square, a rounded square or a squircle. In some embodiments, including the embodiment illustrated in FIGS. 23A and 23B, pole 300 has a cross-sectional shape of a rounded polygon or a rounded square. In other embodiments, pole 300 has a square or generally square cross-sectional shape, or a cross-sectional shape colloquially referred to as a squircle (e.g., a supercircle having a general formula (x−a)⁴+(y−b)⁴=r⁴).

In some embodiments, pole 300 further comprises one or more inner ridges 380A, 380B, 380C and/or 380D. In some embodiments, the one or more inner ridges 380A-D and the pole 300 are integrally formed. In some embodiments, inner ridges 380A-D extend substantially the entire length L of pole 300. In some embodiments, pole 300 includes one inner ridge 380C having a shape and/or size substantially different than a second inner ridge 380A. In such embodiments, asymmetry imparted on the cross-sectional shape of pole 300 may be employed to prompt a user, assembler or installer to affix pole 300 in a desired orientation with respect to other features of the apparatus, for example with respect to the orientation of one or more fins of the apparatus.

In some embodiments, pole 300 further comprises one or more anchoring features 360A, 360B, 360C and/or 360D, which in some embodiments may be used to affix pole 300 to an apparatus as disclosed herein. For example, the embodiment illustrated in FIGS. 23A and 23B comprise four anchoring features 360A-D which each comprise a pair of opposed fins 370A-D, respectively. In some embodiments, anchoring features 360A-D and corresponding opposed fins 370A-D serve as screw or bolt anchors into which the threads of screws or bolts may tap. In other embodiments, anchoring features 360A-D and corresponding pairs of opposed fins 370A-D serve as cavities which squeeze or grip pegs or posts protruding from the top surface of a plate. In such an embodiment, the inner surface of anchoring features 360A-D may include a texture to increase friction with pegs or posts. In other embodiments, the anchoring features 360A-D may be sized slightly smaller than the outside diameter of the pegs or protrusions. In other embodiments, one or more anchoring features 360A-D serve as screw or bolt anchors, while one or more anchoring features 360A-D serve as cavities which squeeze or grip pegs or posts protruding from the top surface of a plate. In some embodiments, the pole 300, the one or more anchoring features 360A-D, and the pairs of opposed fins 370A-D are integrally formed. In some embodiments, anchoring features 360A-D and/or the pairs of opposed fins 370A-D substantially extend the entire length L of pole 300.

In any embodiment provided herein, the drain aperture (e.g., drain aperture 15, drainage aperture 45, drainage aperture 106, drainage aperture 121) may alternatively be positioned in the plate (e.g., rather than in the pole) such that an affixed pole surrounds or substantially surrounds the drain aperture to allow water or other fluid to drain from inside the pole through the plate.

It should be understood that various changes and modifications to the embodiments described herein will be apparent to those skilled in the art. Such changes and modifications may be made without departing from the spirit and scope of the present disclosure and without diminishing its attendant advantages.

We claim:

1. An apparatus for holding a pole, the apparatus comprising:
a plate having a top surface, a bottom surface, a width and a length; and
a fin having a depth and a width, the fin positioned on the bottom surface of the plate wherein the first fin extends substantially perpendicularly from the bottom surface of the plate and extends substantially the width of the plate.

2. The apparatus of claim 1 wherein the fin comprises a beveled edge portion.

3. The apparatus of claim 1 wherein the apparatus further comprises a reinforcing structure at an intersection of the plate and the fin.

4. The apparatus of claim 1 further comprising a drainage aperture through the plate and positioned such that when a pole is affixed to the plate, the drainage aperture is substantially surrounded by the pole.

5. The apparatus of claim 4, wherein the pole has a cross-sectional shape selected from the group consisting of: polygon, closed polygon, equiangular polygon, cyclic polygon, isogonal polygon, equilateral polygon, isotoxal polygon, tangential polygon, rounded polygon, regular polygon, circle, oval, ellipse, square, rounded square and squircle.

6. The apparatus of claim 1, wherein the pole has a cross-sectional shape of a rounded square.

7. The apparatus of claim 1 wherein the plate the fin are integrally formed.

8. The apparatus of claim 1 wherein the fin is resilient.

9. The apparatus of claim 1 wherein the first fin penetrates a surface onto which the plate is positioned.

10. A system for holding a pole, the system comprising:
a plate having a top surface and a bottom surface and defining a length and a width;
a drainage aperture extending through the plate from the top surface to the bottom surface; and
a fin extending substantially perpendicularly away from the bottom surface of the plate, the fin having a width extending substantially the width of the plate.

11. The system of claim 10, wherein the drainage aperture is positioned such that it is substantially out of alignment with the fin.

12. The system of claim 11, wherein the drainage aperture is positioned such that when a pole is affixed to the top surface of the plate, the pole substantially surrounds the drainage aperture.

13. The system of claim 10, wherein the pole has a cross-sectional shape selected from the group consisting of: polygon, closed polygon, equiangular polygon, cyclic polygon, isogonal polygon, equilateral polygon, isotoxal polygon, tangential polygon, regular polygon, circle, oval, ellipse, square, rounded square and squircle.

13. The apparatus of claim 10, wherein the pole has a cross-sectional shape of a rounded square.

14. A pole having a width, a depth, and a length and comprising:
an anchoring feature comprising a cavity and two opposed fins; and
a first inner ridge extending the length of the pole, wherein the pole has a cross-sectional shape selected from the group consisting of: polygon, closed polygon, equiangular polygon, cyclic polygon, isogonal polygon, equilateral polygon, isotoxal polygon, tangential polygon, rounded polygon, regular polygon, circle, oval, ellipse, square, rounded square and squircle.

15. The apparatus of claim 14, wherein the cross-sectional shape is a rounded square.

16. The pole of claim 14 further comprising a second inner ridge, the second inner ridge extending the length of the pole and having a width and/or shape substantially different than the first inner ridge.

17. The pole of claim 16, wherein the pole comprises:
four anchoring features, each anchoring feature substantially extending the length of the pole and comprising a cavity and two opposed fins;
a plurality of first inner ridges, each first inner ridge substantially extending the length of the pole and having substantially similar cross-sectional shape and cross-sectional size; and
a second inner ridge substantially extending the length of the pole and having a cross-sectional shape and/or cross-sectional size substantially different than the plurality of first inner ridges.
